(19) United States
(12) Patent Application Publication
(10) Pub. No.: US 2022/0134972 A1
(43) Pub. Date: May 5, 2022

(54) WIRING MEMBER WITH EXTERIOR MEMBER AND MANUFACTURING METHOD OF WIRING MEMBER WITH EXTERIOR MEMBER

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Tetsuya NISHIMURA, Mie (JP); Daisuke EBATA, Mie (JP); Taku UMEHARA, Mie (JP); Ryuta TAKAKURA, Mie (JP); Kenta ARAI, Mie (JP); Miyu ARAMAKI, Mie (JP); Suguru YASUDA, Mie (JP); Daichi FUKUSHIMA, Mie (JP); Housei MIZUNO, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/434,223

(22) PCT Filed: Jan. 21, 2020
(86) PCT No.: PCT/JP2020/001852

§ 371 Date: Aug. 26, 2021

(30) Foreign Application Priority Data
Mar. 6, 2019 (JP) PCT/JP2019/008754
May 31, 2019 (JP) 2019-103201

(51) Int. Cl. B60R 16/02; F16B 2/08; H01B 13/012

(52) U.S. Cl. CPC B60R 16/0207; H01B 13/012; F16B 2/08

(57) ABSTRACT

A wiring member with an exterior member includes a wiring member, and an exterior member. The wiring member includes a plurality of wire-like transmission members and a base material. The plurality of wire-like transmission members are fixed to the base material in an arrayed state. The exterior member includes an attachment part. The attachment part is attached to a region of the wiring member having a reduced width. In a state in which the attachment part is attached to the wiring member, a state having the reduced width of the wiring member is maintained. In the region where the attachment part is attached, at least one of the attachment part and the base material entirely covers the plurality of wire-like transmission members along a longitudinal direction.

### TECHNICAL FIELD.

The present disclosure relates to a wiring member with an exterior member and a manufacturing method of the wiring member with an exterior member.

### BACKGROUND ART

Patent Document 1 discloses a wire harness. The wire harness includes a functional exterior member formed into a sheet-like shape, and an electric wire disposed to overlap the functional exterior member in at least a part of a region along a longitudinal direction. At least a portion of a part in which an insulation covering of the electric wire and the functional exterior member overlap is welded.

### PRIOR ART DOCUMENTS

### Patent Documents

Patent Document 1: Japanese Patent Application Laid-Open No. 2018-137208

Patent Document 2: Japanese Patent Application Laid-Open No. 2011-149456

### SUMMARY

### Problem to be Solved by the Invention

In the wire harness described in Patent Document 1, it is desirable to protect the entire circumference of the electric wire.

In view of this, the object is to provide a technology capable of protecting the entire circumference of a wire-like transmission member in a wiring member.

### Means to Solve the Problem

A wiring member with an exterior member according to the present disclosure is a. wiring member with an exterior member that includes a wiring member, and an exterior member. The wiring member includes a plurality of wire-like transmission members and a base material. The plurality of wire-like transmission members are fixed to the base material in an arrayed state. The exterior member includes an attachment part. The attachment part is attached to a region of the wiring member having a reduced width. In a state in which the attachment part is attached to the wiring member, a state having the reduced width of the wiring member is maintained. In the region where the attachment part is attached, at least one of the attachment part and the base material entirely covers the plurality of wire-like transmission members along a longitudinal direction.

### Effects of the Invention

According to the present disclosure, the entire circumference of the wire-like transmission member can be protected in the wiring member.

### BRIEF DESCRIPTION OF DRAWINGS

FIG. 1 is a side view illustrating a wiring member with a fixing member according to the first embodiment.

FIG. 2 is a front view illustrating the wiring member with a fixing member according to the first embodiment.

FIG. 3 is a perspective view illustrating a wiring member before a base material is bent.

FIG. 4 is a front view illustrating a modification of the wiring member.

FIG. 5 is a front view illustrating a state in which the fixing member is attached to the wiring member.

FIG. 6 is a front view illustrating a wiring member with a fixing member according to the second embodiment.

FIG. 7 is an explanatory diagram illustrating a state in which the fixing member is open.

FIG. 8 is a side view illustrating a wiring member with a fixing member according to the third embodiment.

FIG. 9 is a front view illustrating a wiring member with a fixing member according to the third embodiment.

FIG. 10 is a front view illustrating a wiring member with an exterior sheet according to the fourth embodiment.

FIG. 11 is a plan view illustrating a state in which the exterior sheet is attached to the wiring member.

FIG. 12 is a front view illustrating another modification of the wiring member.

FIG. 13 is a perspective view illustrating a wiring member with a protector according to the fifth embodiment.

FIG. 14 is a plan view illustrating a wiring member with a tube according to the sixth embodiment.

FIG. 15 is a plan view illustrating a wiring member a grommet according to the seventh embodiment.

### DESCRIPTION OF EMBODIMENTS

### Description of Embodiments of Present Disclosure

First, embodiments of the present disclosure will be listed below.

A wiring member with an exterior member according to the present disclosure is as follows.

(1) A wiring member with an exterior member includes a wiring member, and an exterior member. The wiring member includes a plurality of wire-like transmission members and a base material. The plurality of wire-like transmission members are fixed to the base material in an arrayed state. The exterior member includes an attachment part. The attachment part is attached to a region of the wiring member having a reduced width in a state in which the attachment part is attached to the wiring member, a state having the reduced width of the wiring member is maintained. In the region where the attachment part is attached, at least one of the attachment part and the base material entirely covers the plurality of wire-like transmission members along a longitudinal direction. In the region where the attachment part is attached in the wiring member, at least one of the attachment part and the base material entirely covers the plurality of wire-like transmission members along the longitudinal direction, and thus the entire circumference of the wire-like transmission members can be protected by at least one of the attachment part and the base material in the wiring member. Here, the wire-like transmission member is a wire-like member that transmits electrical power, light, or the like.

(2) The wiring member may have a region having a larger width than the region where the exterior member is attached, on both sides with respect to the region where the exterior member is attached along the longitudinal direction. In this case, in the wiring member, both the sides of the region where the exterior member is attached have a large width, and thus the exterior member is less liable to be shifted along the longitudinal direction.

(3) The wiring member may have a region having a larger width than the region where the exterior member is attached, only on one side with respect to the region where the exterior member is attached along the longitudinal direction. In this case, in the wiring member, the exterior member can be externally attached to the end portion, and a part on the intermediate portion side can be flat.

(4) The wiring member may further include a region provided so as to have the width gradually increased from the region where the exterior member is attached toward the region having the larger width. With this, an edge is less liable to be generated between the region where the exterior member is attached and the region having a larger width, and damage due to the edge at the time of vibration or the like can be less liable to be caused.

(5) In the region having the reduced width of the wiring member, cross-section may be in spirally wound state in the wiring member. In this case, the base material can easily form the bent state so as to surround the wire-like transmission member.

(6) In the region having the reduced width of the wiring member, cross-section may be in a spirally wound state respectively separately on one side part and another side part in the wiring member. In this case, the height of the wiring member can be lowered in comparison to a case in which winding is performed in one spiral manner from one side part toward another side part.

(7) The exterior member may be a fixing member. The fixing member may include the attachment part, and a fixing part being connected to the attachment part and being fixed to a fixing target of the wiring member. In the region having the reduced width of the wiring member, the base material may be bent so as to surround plurality of wire-like transmission members. In this case, the entire circumference of the wire-like transmission member is protected, with the fixing member bet provided.

(8) The fixing member may be a molded item obtained by integrally molding the attachment part and the fixing part. The attachment part may include an annular part being capable of changing a state between an annular state and at non-annular state and surrounding the wiring member in the annular state, and an annular shape maintaining part being provided at one end portion of the annular part and stopping another end portion of the annular part to maintain the annular pail in the annular state. In this case, as the fixing member, a general-purpose band clamp, a corrugated clamp, or the like can be used.

(9) When a part of the wiring member coming in contact with the annular part constitutes a contact region, and a part of the wiring member not coming in contact with the annular part constitutes a non-contact region, a coefficient of friction in an outer surface of at least a part of the contact region with respect to the annular part may be higher than a coefficient of friction in an outer surface of the non-contact region with respect to the annular part. In this case, the fixing member is less liable to be shifted.

(10) An intermediation member being fixed at an outer circumferential portion of the base material and being interposed between the annular part and the base material may be further included. A coefficient of friction in an outer surface of the intermediation member with respect to the annular part may be higher than a coefficient of friction in an outer surface of the base material with respect to the annular part. In this case, the annular part can reduce rotation of the wiring member in the circumferential direction.

(11) The fixing member may be a molded item obtained by integrally molding the attachment part and the fixing part. The attachment part may be formed into a plate-like shape extending in a longitudinal direction of the wiring member. The wiring member with the exterior member may further include a bundling member configured to bundle the attachment part and the wiring member. In this case, as the fixing member, a general-purpose taping-type clamp or the like can be used.

(12) The exterior member may be an exterior sheet. A part in which the exterior sheet is wound around the region having the reduced width of the wiring member may constitute the attachment part. In this case, the wiring member can be protected by the exterior sheet.

(13) The exterior member may be a protector including an accommodation part. The accommodation part may include a bottom part, and a side wall part protruding from the bottom part, and the accommodation may accommodate the region having the reduced width of the wiring member to constitute the attachment part. In this case, the wiring member can be protected by the protector.

(14) The exterior member may be a tube. The tube may accommodate the region having the reduced width of the wiring member to constitute the attachment part. In this case, the wiring member can be protected by the tube.

(15) The exterior member may be a grommet including a small-diameter cylindrical part, and a large-diameter cylindrical part being connected to the small-diameter cylindrical part. The small-diameter cylindrical part may accommodate the region having the reduced width of the wiring member to constitute the attachment part. In this case, the wiring member can be protected by the grommet.

(16) The base material may include a body part in which the plurality of wire-like transmission members are disposed, and an extension piece in which the plurality of wire-like transmission members are not disposed, the extension piece extending from the body part. In the wiring member, the extension piece may be wound around once or more on an outer side of the body part. In this case the entire outer side of the body part can be covered by the extension piece.

(17) When a part of the wiring member coming in contact with the attachment part constitutes a contact region, and a part of the wiring member not coming in contact with the attachment part constitutes a non-contact region, a coefficient of friction in an outer surface of at least a part of the contact region with respect to the attachment part may be higher than a coefficient of friction in an outer surface of the non-contact region with respect to the attachment part. In this case, the exterior member is less liable to be shifted.

(18) Further, a manufacturing method of a wiring member with an exterior member according to the present disclosure is a manufacturing method of a wiring member with an exterior member, including the steps of: preparing a wiring member formed flat, the wiring member including a plurality of wire-like transmission members, and a base material in which the plurality of wire-like transmission members are fixed in an arrayed state; reducing width of at least a part of a region of the wiring member along a longitudinal direction; and attaching an attachment part in the exterior member to the region having the reduced width in the wiring member, and maintaining the wiring member in a state with the reduced width and a state in which at least one of the attachment part and the base material entirely covers the plurality of wire-like transmission members along the longitudinal direction. In the region where the attachment part is attached in the wiring member, at least one of the attachment part and the base material entirely covers the plurality of wire-like transmission members along the longitudinal direction, and thus the entire circumference of the wire-like transmission members can be protected by at least one of the attachment part and the base material in the wiring member.

### Details of Embodiments of Present Disclosure

Specific examples of a wiring member with an exterior member according to the present disclosure will be described below with reference to the drawings. Note that the present invention is not limited to these examples but is recited in the claims, and encompasses meanings equivalent to those of the claims and all modifications within the scope of the claims.

### First Embodiment

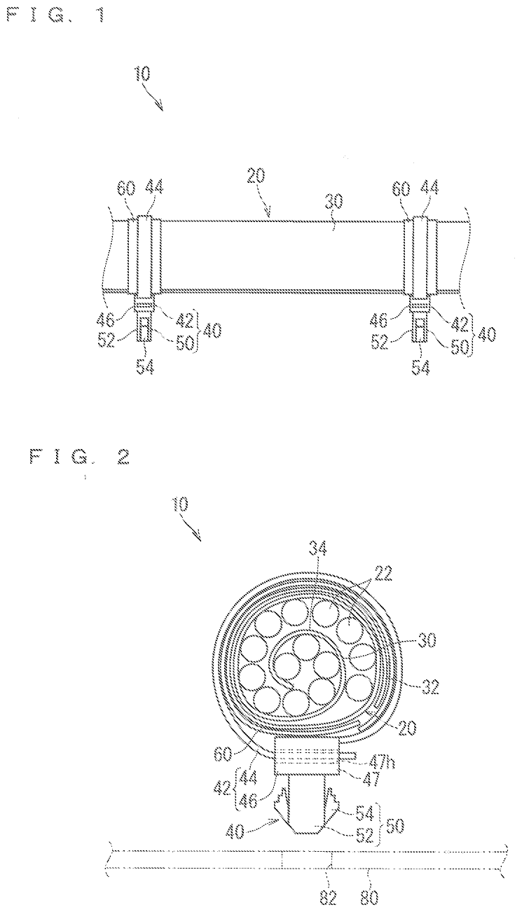

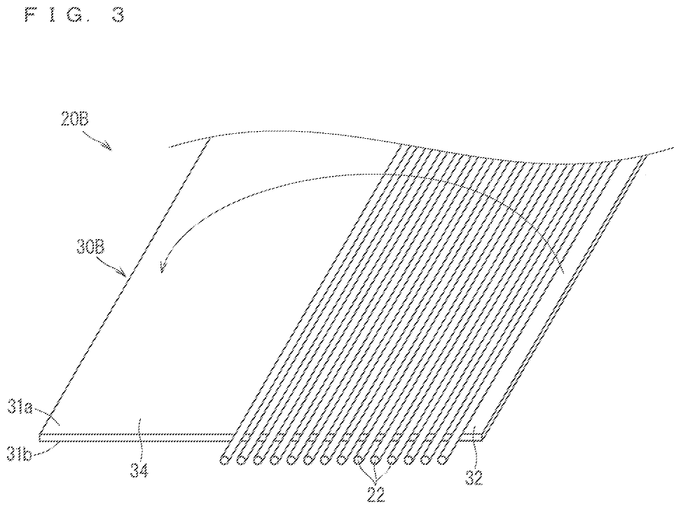

A wiring member with an exterior member according to the first embodiment will be described below. The wiring member with an exterior member according to the first embodiment is an example in which the exterior member is a fixing member. In other words, the wiring member with an exterior member according to the first embodiment is a wiring member with a fixing member. A wiring member with an exterior member according to the second embodiment and a wiring member with an exterior member according to the third embodiment described below are also each a wiring member with a fixing member. Note that it is only necessary that the exterior member be a member that is mounted on the outer side of the wiring member. FIG. 1 is a side view illustrating a wiring member with a fixing member 10 according to the first embodiment. FIG. 2 is a front view illustrating the wiring member with a fixing member 10 according to the first embodiment. FIG. 3 is a perspective view illustrating a wiring member 20 before a base material 30 is bent.

The wiring member with a fixing member 10 includes a wiring member 20 and a fixing member 40. The wiring member with a fixing member 10 according to the present example further includes an intermediation member 60.

The wiring member 20 is a member that is mounted on a vehicle, and that supplies electrical power to each device of the vehicle and transmits and receives signals. The wiring member 20 includes a plurality of wire-like transmission members 22, and a base material 30 that is fixed in a state in which the plurality of wire-like transmission members 22 are arrayed. In the wiring member 20, the base material 30 is bent so as to surround the wire-like transmission members 22. As illustrated in FIG. 3 the wiring member 20 is formed as follows; the wiring member 20 is once formed into a flat shape, and then the base material 30 is bent. In the following, the wiring member 20 before the base material 30 is bent is referred to as a flat wiring member 20B. The flat wiring member 20B has its dimension in the thickness direction being formed smaller than the dimension in a surface direction perpendicular to the thickness direction. Here, the flat wiring member 20B is formed with the plurality of wire-like transmission members 22 being fixed on the base material 30.

It is only necessary that the wire-like transmission member 22 is a wire-like member that transmits electrical power or light. For example, the wire-like transmission member 22 may be a general wire having a core wire and a covering around the core wire, or may also be a hare conductive wire, a shielded wire, an enamel wire, a nichrome wire, or an optical fiber.

The wire-like transmission member 22 transmitting the electrical power may be various kinds of signal lines or various kinds of power lines. The wire-like transmission member 22 transmitting the electrical power may be used as an antenna or coil, for example, transmitting or receiving a signal or electrical power to or from a space.

The wire-like transmission member 22 includes a transmission wire body that transmits electrical power, light, or the like, and a covering that covers the transmission wire body. When the wire-like transmission member 22 is a general wire, the transmission wire body is a core wire, and the covering is an insulation covering. In the example illustrated in FIG. 2, a plurality of wire-like transmission members 22 having the same diameter and structure are disposed on one base material 30. However, it is only necessary that the diameter, structure, or the like of the plurality of wire-like transmission members 22 be set as appropriate, and the wire-like transmission members 22 having different diameters, structures, or the like may be disposed on the same base material 30.

The wire-like transmission member 22 may be a single wire-like material, or may be a composite of a plurality of wire-like materials (twist wire, a cable in which a plurality of wire-like materials are collected and then covered by a sheath, or the like). At an end portion of the wire-like transmission member 22, a terminal, a connector, or the like is provided as appropriate, according to a mode of connecting with a member to be connected with the wire-like transmission member 22.

The base material 30 includes a body part 32 on which the wire-like transmission members 22 are disposed, and an extension piece 34 that extends from the body part 32. On the extension piece 34, the wire-like transmission members 22 are not disposed. In the wiring member 20, the extension piece 34 is wound around once or more on the outer side of the body part 32.

Although the material constituting the base material 30 is not particularly limited, the base material 30 is, for example, made of a material containing resin such as polyvinyl chloride (PVC), polethylene terephthalate (PET), and polypropylene (PP). The base material 30 may for example, a fiber material including fibers, such as nonwoven fabrics, a cloth, and knitted fabrics, or may be a non-fiber material. The non-fiber material may include a solid member whose inside is uniformly filled, a foamed material that is made of resin being foamed, or the like. The base material 30 may include a material such as metal.

The base material 30 may be a single layer, or may have a plurality of layers being stacked. When a plurality of layers are stacked, for example, it is considered that a resin layer and another resin layer are stacked. Alternatively, for example, it is considered that a resin layer and a metal layer are stacked. Further the base material 30 may be a material in which a non-fiber material layer and another non-fiber material layer are placed on one another, may be a material in which a non-fiber material layer and a fiber material layer are placed on one another, or may be a material in which a fiber material layer and another fiber material layer are placed on one another.

The base material 30 holds the wire-like transmission members 22 in a two-dimensionally positioned state in the flat wiring member 20B. In the following, if the base material 30 in a bent state in the wiring member 20 and the base material 30 in a spread state before being bent in the flat wiring member 20B need to be distinguished from each other, the base material 30 in a spread state before being bent in the flat wiring member 203 is referred to as a base material 30B.

The wire-like transmission members 22 are disposed on one main surface of the base material 30B. The base material 30B holds the plurality of wire-like transmission members 22 in an arrayed state. The base material 30B is a bendable member. In the following, in the base material 300, a main surface to which the wire-like transmission members 22 is fixed is referred to as a main surface 31a, and a main surface on the opposite side of the main surface 31a is referred to as a main surface 31b.

The wire-like transmission members 22 are fixed to the base material 30B in a state of being disposed along a predetermined route on the main surface 31a of the base material 30B. The base material 30B is formed into a band-like shape that extends along the route of the wire-like transmission members 22. It is only necessary that the route of the wire-like transmission members 22 on the base material 30B be set as appropriate, and in the present example, the wire-like transmission members 22 have a part that is linearly disposed on the base material 30B. Mainly, the base material 30B is bent so as to surround the wire-like transmission members 22 in the part where the wire-like transmission members 22 are linearly disposed.

The wire-like transmission members 22 may include a part being bent and disposed on the base material 30B. In this case, the base material 30B may also be formed to be bent along the main surface 31a in accordance with the bending of the wire-like transmission members 22. The plurality of wire-like transmission members 22 may be disposed in different routes, such as in a manner of branching or crossing on the base material 30B. In this case, the base material 30B may also be formed so as to branch or cross. With the base material 30B being thrilled into a shape along the route of the of wire-like transmission members 22, interference between the base material 30B and other components can be reduced, and weight can be reduced, for example.

The wire-like transmission members 22 and the base material 30B are fixed, and the fixed state is maintained even after the base material 30B is bent to be the base material 30. As the fixing mode, contact area fixation may be used, non-contact area fixation may be used, or both of them may be used at the same time. Here, the contact area fixation is a mode in which the wire-like transmission members 22 and the base material 30B are fixed to each other with their contact part coming in contact with each other. Further, the non-contact area fixation is a fixing mode different from the contact area fixation. For example, the non-contact area fixation is a mode to maintain the wire-like transmission members 22 and the base material 30B in a state of being fixed to each other. This mode is obtained as follows, for example: a thread, another base material, an adhesive tape, or the like presses the wire-like transmission members 22 down toward the base material 30B, or a thread, another base material, an adhesive tape, or the like surrounds the wire-like transmission members 22 and the base material 30B, for example, so as to interpose the wire-like transmission members 22 and the base material 30B. The following description will be given based on the assumption that the wire-like transmission members 22 and the base material 30B are in a state of the contact area fixation. Each description related to the contact area fixation can also be applied to the non-contact area fixation unless the application is impossible.

As a mode of the contact area fixation, indirect fixation may be used, direct fixation may be used, or both of them may be used at the same time in different regions. Here, the indirect fixation is a mode in which the wire-like transmission members 22 and the base material 30B are fixed to each other by being indirectly coming in contact via an intermediation member 60 being provided therebetween, such as an adhesive agent, a pressure sensitive adhesive, a double-sided adhesive tape, and a hook-and-loop fastener. Further, the direct fixation is a mode in which the wire-like transmission members 22 and the base material 30B are fixed to each other by being directly coming in contact without the use of a material being separately provided, such as an adhesive agent. In the direct fixation, for example, it is considered that the wire-like transmission members 22 and the base material 30B are fixed by coming in contact with resin included in at least one of those being melted. The following description will be given based on the assumption that the wire-like transmission members 22 and the base material 30B are in a state of the direct fixation. Each description related to the direct fixation can also be applied to the indirect fixation, unless the application is impossible.

In forming the state of such a direct fixation, the resin is considered to be melted by heat or a solvent, for example. That is to say, the state of the direct fixation may be the state of the direct fixation by the heat or the state of the direct fixation by the solvent. The direct fixation by the heat is preferable.

At this time, a means of forming the state of the direct fixation is not particularly limited, but various means including a known means such as welding, fusion, and melting joint can be used. For example, when the state of the direct fixation by the heat is formed by welding, various welding means such as ultrasonic welding, heating-pressurizing welding, hot air welding, and high frequency welding can be adopted. When the state of the direct fixation is formed by these means, the wire-like transmission members 22 and the base material 30B are in the state of the direct fixation by these means. Specifically, when the state of the direct fixation is formed by the ultrasonic welding, for example, the wire-like transmission members 22 and the base material 30B are in the state of the direct fixation by the ultrasonic welding. A portion where the state of the direct fixation by the heat is formed by the welding (a fixing portion between the wire-like transmission members 22 and the base material 30B) may be referred to as a welding part, and herein, the fixing portion by the ultrasonic welding may be referred to as an ultrasonic welding part, and the fixing portion by the heating-pressurizing welding may be referred to as a heating-pressurizing welding part, for example.

In the case of the direct fixation only the resin in the covering of the wire-like transmission member 22 may be melted, or only the resin included in the base material 30B may be melted. The resin which has been melted in these cases is stuck on an outer surface of the resin on the other side, and a relatively clear interface may be formed in some cases. In the case of the direct fixation, both the resin included in the covering of the wire-like transmission member 22 and the resin included in the base material 30B may be melted. In this case there may be a case where both the resins are mixed and a clear interface is not formed. In particular, when the covering of the wire-like transmission members 22 and the base material 30B include compatible resin such as the same resin material, there may be a case where both the resins are mixed and a clear interface is not be formed.

As the base material 30B that is directly fixed to the wire-like transmission members 22, a material obtained by stacking a first sheet-like member and a second sheet-like member may be used. The first sheet-like member is suitable for the direct fixation with the wire-like transmission members 22 than the second sheet-like member. For example, the first sheet-like member is a material that is formed into a solid sheet-like shape by an isologous material of covering of the wire-like transmission members 22. The first sheet-like member appears on the main surface 31a of the base material 30B. The wire-like transmission members 22 are directly fixed to the first sheet-like member. The second sheet-like member is a member having protection performance higher than that of the first sheet-like member. For example, the second sheet-like member is nonwoven fabrics. The second sheet-like member appears on the main surface 31b of the base material 30B. The second sheet-Like member appears on the outer surface of the wiring member 20. Although in the base material 30 according to the present example, a layer of a metal sheet-like member is not stacked, a layer of a metal sheet-like member may be stacked.

In the wiring member 20, the cross-section is in a spirally wound state. “The cross-section is in a spirally wound state” is, as illustrated in FIG. 3, a state in which winding is performed so that a portion to be newly wound from one edge portion in the base material 30B being a winding start portion toward another edge portion being a winding end portion overlaps the outer side of a portion that has already been wound. In the spirally wound state, the winding start portion is located on the inner circumferential side, and the winding end portion is located on the outer circumferential side. When the extension piece 34 is provided on the base material 30, as illustrated in FIG. 3, wound may be performed so that the main surface 31a of the base material 30 is located either on the inside or outside with respect to the main surface 31b. When the extension piece 34 is not provided, it is satisfactory that the main surface 31a is wound so as to be located on the inside with respect to the main surface 31b.

If the base material 30 is bent so as to surround the wire-like transmission members 22, the cross-section need not necessarily be in the spirally wound state in the wiring member 20. For example, as illustrated in FIG. 4, the wiring member 20 may be folded so that the wire-like transmission members 22 are located on the inside with respect to the base material 30.

The wire-like transmission member 22 that come in contact with both of the base material 30 on the inner circumferential side and the base material 30 on the outer circumferential side may be present in the in the wiring member 20. In the example illustrated in FIG. 2, the wire-like transmission member 22 on the outer circumferential side in the spiral wiring member 20 (the wire-like transmission member 22 on the outside of the part wound around once from the center portion) comes in contact with both of the base material 30 on the inner circumferential side and the base material 30 on the outer circumferential side with respect to the wire-like transmission member 22. The wire-like transmission member 22 that comes in contact with both of the base materials 30 in inner and enter directions with respect to the wire-like transmission member 22 is joined to only one of both of the base materials 30 in the inner and outer directions. This is because the flat wiring member 20B is wound to be the wiring member 20. In the example illustrated in FIG. 2, the main surface 31a is wound so as to be located on the inside with respect to the main surface 31b, and thus the wire-like transmission member 22 coming in contact with both of the base materials 30 in the inner and outer directions is joined to only the base material 30 on the outer circumferential side out of both of the base materials 30 in the inner and outer directions.

There may be a portion in which the wire-like transmission members 22 not adjacent in the wiring member 20 directly face each other without interposing the base material 30 therebetween. In the example illustrated in FIG. 2, there is a portion in which the wire-like transmission members 22 directly face each other without interposing the base material 30 therebetween at the center portion of the spiral wiring member 20. Because the flat wiring member 20B is wound to be the wiring member 20, there may be a portion in which the wire-like transmission members 22 thready face each other without interposing the base material 30 therebetween.

The base material 30 may be formed so that the thickness is entirely uniform, or may be formed so that parts thereof have a portion having different thicknesses. When the base material 30 is formed so that parts thereof have a portion having different thicknesses, it is considered that the thickness of a part having a high probability of coming in contact with a surrounding component in a state in which the wiring member 20 is disposed in a vehicle or the like is set larger than the thickness of a part having a low probability of coming in contact with a surrounding component. In this manner, when the base material 30 is formed so that parts thereof have a portion having different thicknesses, for example, the parts having different thicknesses may be present separately in the longitudinal direction of the wire-like transmission members 22, or the parts having different thicknesses may be present along the direction in which the wire-like transmission members 22 are arrayed.

The fixing member 40 includes an attachment part 42 that is attached to the wiring member 20, and a fixing part 50 that is connected to the attachment part 42 and that is fixed to a fixing target 80 of the wiring member 20. The attachment part 42 is attached so as to be located on the outside of the base material 30. In a state in which the attachment part 42 is attached to the wiring member 20, the base material 30 is maintained in a bent state. With the fiat wiring member 20B being wound to be the wiring member 20 and the attachment part 42 being removed from the wiring member 20, the base material 30 spreads and can be restored from the wiring member 20 to the flat wiring member 20B.

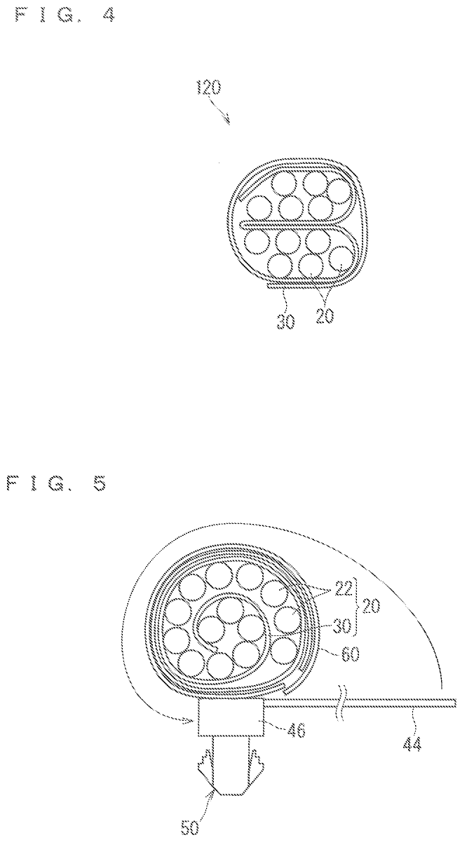

The fixing member 40 according to the present example is a molded item obtained by integrally molding the attachment part 42 and the fixing part 50. The attachment part 42 includes an annular part 44 and an annular shape maintaining part 46. The annular part 44 can change its state between an annular state as illustrated in FIG. 2 and a non-annular state as illustrated in FIG. 5. The annular part 44 surrounds the wiring member 20 in the annular state. The annular shape maintaining part 46 is provided at one end portion of the annular part 44. The annular shape maintaining part 46 stops another end portion of the annular part 44 to maintain the annular part 44 in the annular state.

Specifically, in the present example, a band clamp 40 is fused as the fixing member 40. In other words, the annular part 44 is a band part 44, and the annular shape maintaining part 46 is a band fixing part 46. The band part 44 is formed into a narrow band-like shape so as to be entirely bent and deformed. The band fixing part 46 includes, for example, a body part 47 in which a band insertion hole 47h that allows the band part 44 to be inserted therethrough is formed, and an engaging protrusion (not shown) that is formed to protrude from an inner circumferential surface of the band insertion hole 47h toward a space in the band insertion hole 47h. In the band part 44, a plurality of engaged parts (not shown) with which the engaging protrusion can be selectively engaged are formed. In a state in which the band part 44 is inserted in to the band insertion hole 47h, when the engaging protrusion is engaged with the engaged part, the band part 44 is stopped at the band fixing part 46.

In the example illustrated in FIG. 2, in a state in which an intermediate portion of the band part 44 is wound around an outer circumferential portion of the wiring member 20, when a tip end portion of the band part 44 is fixed to the band fixing part 46, the attachment part 42 is in a state of being attached to the wiring member 20. It is satisfactory that the attachment part 42 fastens the wiring member 20. In this case, in the part where the attachment part 42 is attached, it is considered that the nonwoven fabrics in the base material 30 are partially compressed as compared to the nonwoven fabrics in the base material 30 at a part where the attachment part 42 is not attached. Regarding the nonwoven fabrics in the base material 30 at the where the attachment part 42 is attached, the compressed state is restored when the attachment part 42 is removed. Further, the nonwoven fabrics in the base material 30 at the where the attachment part 42 is attached maintain a soft state. It is satisfactory that the nonwoven fabrics in the base material 30 at the where the attachment part 42 is attached maintain a state that is as soft as or that is slightly less soft than the nonwoven fabrics in the base material 30 at the where the attachment part 42 is not attached.

The fixing part 50 in the band clamp 40 is formed so as to be capable of being engaged with a through hole 82 that is formed in a plate-like member 80 such as a panel. The fixing part 50 includes a pillar part 52 that is formed to protrude from the band fixing part 46, and a pair of engagement pieces 54 that is formed to protrude from a tip end portion of the pillar part 52 toward a lateral side and a base end side of the pillar part 52. On the base end side of the pair of engagement pieces 54, the pair of engagement pieces 54 is formed so that its interval gradually becomes wider toward its tip end side. Further, when the fixing part 50 is inserted into the through hole 82 and comes in contact with a circumferential edge portion of the through hole 82, the pair of engagement pieces 54 can be elastically deformed so that its interval is reduced by receiving a force from the circumferential edge portion of the through hole 82. After the tip end portion passes through the through hole 82, the pair of engagement pieces 54 is elastically restored, and is engaged with the circumferential edge portion of the through hole 82. With this, the fixing part 50 is in a state of being fixed to the fixing target 80.

The intermediation member 60 is fixed to an outer circumferential portion of the base material 30. The intermediation member 60 is interposed between the annular part 44 and the base material 30. A coefficient of friction in the outer surface of the intermediation member 60 with respect to the annular part 44 is higher than a coefficient of friction in the outer surface of the base material 30 with respect to the annular part 44. The material of the intermediation member 60 is not particularly limited on the condition that the coefficient of friction in the outer surface of the intermediation member 60 with respect to the annular part 44 is higher than the coefficient of friction in the outer surface of the base material 30 with respect to the annular part 44. For example, it can be assumed that, as the intermediation member 60 adhesive tape is wot rid and fixed to the outer surface of the base material 30.

In the wiring member, the use of the intermediation member in order to increase the coefficient of friction with the annular part is not an essential configuration. In a part of the region of the base material, the coefficient of friction with the annular part may be increased by increasing surface roughness more than other parts or the like. In other words, it is only necessary that, when a part of the wiring member coming in contact with the annular part constitutes a contact region, and a part of the wiring member not coming in contact with the annular part constitutes a non-contact region, a coefficient of friction in an outer surface of at least a part of the contact region with respect to the annular part be higher than a coefficient of friction in an outer surface of the non-contact region with respect to annular part. With this configuration as well, the fixing member is less liable to be shifted.

<Manufacturing Method>

A manufacturing method of the wiring member with a fixing member 10 will be described. The manufacturing method of the wiring member with a fixing member 10 includes the following step (a), step (b), and step (c).

Step (a) is a step of preparing the wiring member (flat wiring member 20B) formed flat, the wiring member including the plurality of wire-like transmission members 22, and the base material 30 in which the plurality of wire-like transmission members 22 are fixed in an arrayed state. Here, as the flat wiring member 20B, a member that is formed flat with the plurality of wire-like transmission members 22 being directly fixed on the main surface 31a of the base material 30B in an arrayed state is prepared.

Step (b) is a step of reducing the width of at least a part of a region of the wiring member along the longitudinal direction. Here, Step (b) is a step of bending the base material 30B so that the base material 30 surrounds the wire-like transmission members 22. Here, both of the body part 32 and the extension piece 34 of the base material 30B are bent. Here, a portion to be newly wound from one edge portion along an aligning direction of the wire-like transmission members 22 out of the flat wiring member 20B toward another edge portion is located on the outer circumferential side of a portion that has already been wound. With this, in the wiring member 20 after the base material 30 is bent, the cross-section is in a spirally wound state. When arrangement of the wire-like transmission members 22 is focused, the arrangement is changed from a state of side-by-side arrangement in one row in the flat wiring member 20B to spiral arrangement in the wiring member 20. The wiring member 20, which is obtained by winding the flat wiring member 20B to which the wire-like transmission members 22 are fixed to the base material 30B in advance, is used, and thus the wire-like transmission members 22 need not be pressed, and winding is easily performed. Further, in a state of being the wiring member 20, arrangement of the wire-like transmission members 22 is less liable to be disturbed from predetermined arrangement.

Step (c) is a step of attaching the attachment part in the exterior member to the region having the reduced width in the wiring member, and maintaining the wiring member in a state with the reduced width and a state in which at least one of the attachment part and the base material entirely covers the plurality of wire-like transmission members along the longitudinal direction. Here, Step (e) is a step of attaching the attachment part 42 in the fixing member 40 to the wiring member 20 so as to be located on outside of the base material 30 so as to maintain the base material 30 in a bent state, the fixing member 40 including the attachment part 42, and the fixing part 50 being connected to the attachment part 42 and being fixed to the fixing target 80 of the wiring member 20. Here, the fixing member 40 is the band damp 40 including band part 44 and the band fixing part 46 as the attachment part 42. In this case, after the band part 44 is externally wound around the base material 30, the tip end portion of the hand part 44 is caused to pass through the band insertion hole 47h of the band fixing part 46, and is fixed.

Note that, when the wiring member 20 including the intermediation member 60 is manufactured, it is satisfactory that a step of providing the intermediation member be provided prior to stop (c). For example, when the intermediation member 60 is an adhesive tape, after step (b), an adhesive tape is wound around at the outer circumferential portion at the where the fixing member 40 is provided in the wiring member 20. In this case, it is satisfactory that winding is performed so that the adhesive tape as the intermediation member 60 stops the winding end portion at the part to overlap the inner circumferential side of the winding end portion. With this, the intermediation member 60 functions as a provisional stopping part that reduces spreading of the wiring member 20 before the fixing member 40 is provided.

According to the wiring member with a fixing member 10, in a state in which the attachment part 42 is attached to the wiring member 20 in the wiring member 20, the base material 30 is maintained in a bent state so as to surround the wire-like transmission members 22. Thus, in the wiring member 20, the entire circumference of the wire-like transmission members 22 can be protected by the base material 30. In the wiring member 20, the cross-section is in a spirally wound state, and thus the base material 30 can easily form the bent state so as to surround the wire-like transmission members 22.

The fixing member 40 may be a molded item obtained by integrally molding the attachment part 42 and the fixing part 50. The attachment part 42 may include the annular part 44 being capable of changing a stale between an annular state and a non-annular state and surrounding the wiring member 20 in the annular state, and the annular shape maintaining part 46 being provided at one end portion of the annular part 44 and stopping another end portion of the annular part 44 to maintain the annular part 44 in the annular state. In this case, as the fixing member 40, the general-purpose band clamp 40 can be used as in the present example.

The base material 30 includes the body part 32 to which the wire-like transmission members 22 are fixed, and the extension piece 34 extending from the body part 32. In the wiring member 20, the extension piece 34 is wound around once or more on the outer side of the body part 32. Thus, the entire outer side of the body part 32 can be covered by the extension piece 34. In wiring member 20, the extension piece 34 need not necessarily wound around once or more on the outer side of the body part 32. A region in which the extension piece 34 is wound around on the outer side of the body part 32 in the wiring member 20 may be a half or more or less than the whole of the outer side, or may be less than a half thereof.

An intermediation member 60 being fixed at an outer circumferential portion of the base material 30 and being interposed between the annular part 44 and the base material 30 is further included. A coefficient of friction in an outer surface of the intermediation member 60 with respect to the annular part 44 is higher than a coefficient of friction in an outer surface of the base material 30 with respect to the annular part 44. Thus, the annular part 44 can reduce rotation of the wiring member 20 in the circumferential direction. The intermediation member 60 need not necessarily be provided. When the coefficient of friction between the outer surface of the base material 30 and the inner surface of the annular part 44 is high, rotation between the base material 30 and the annular part 44 can be reduced even without the provision of the intermediation member 60. For example, when the outer surface of the base material 30 is a member that is not significantly slippery, or when a non-slip protrusion is formed on the inner surface of the annular part 44, the coefficient of friction between the outer surface of the base material 30 and the inner surface of the annular part 44 can be increased.

### Second Embodiment

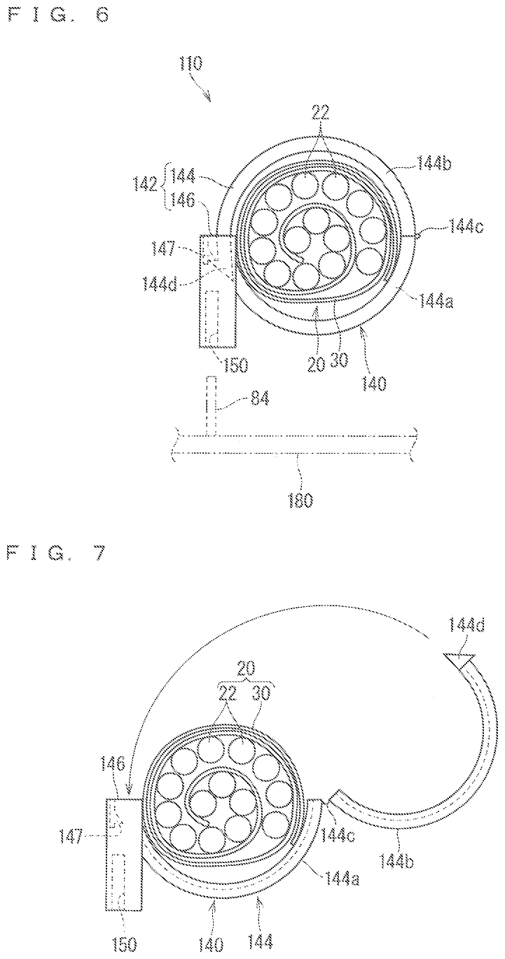

A wiring member with a fixing member according to the second embodiment will be described. FIG. 6 is a front view illustrating wiring member with a fixing member 110 accordant to the second embodiment. FIG. 7 is an explanatory diagram illustrating a state in which a fixing member 140 is open. Note that constituent elements similar to those described above in the description of the present embodiment are denoted by the same reference signs and description thereof will be omitted. The same applies to description of other embodiments described below.

Regarding the wiring member with a fixing member 110 according to the present example, the shape of the fixing member 140 is different from the shape of the fix member 40 according to the first embodiment. Specifically, in the present example as well, the fixing member 140 is a molded item obtained by integrally molding an attachment part 142 and a fixing part 150, and attachment part 142 includes an annular part 144 that can change its state between an annular state and a non-annular state and that surrounds the wiring member 20 in the annular state, and an annular shape maintaining part 146 that is provided one end portion of the annular part 144, and that stops another end portion of the annular part 144 to maintain the annular part 144 in the annular state. The present example is an example in which a hinge pivotable clamp 140 (also referred to as a corrugated clamp) is used as the fixing member 140.

In the clamp 140, the annular part 144 includes a plurality of (here, two) partial annular parts 144a and 144b, and a hinge part 144c. The partial annular parts 144a and 144b have a shape that is divided in the circumferential direction. The plurality of partial annular parts 144a and 144b form an annular shape when being combined together. Each of the partial annular parts 144a and 144b has such rigidity as to be capable of maintaining a partially annular state. Ribs are provided on the inner surfaces of the partial annular parts 144a and 144b. The ribs continue in the circumferential direction. A plurality of ribs are provided so as to be away from each other in the axial direction. The ribs can dig into the outer surface of the wiring member 20. The hinge part 144c relatively pivotably couples the partial annular parts 144a and 144b being adjacent to each other. For example, the hinge part 144c is a part that is formed to be thin.

The annular shape maintaining part 146 is provided at circumferential end portions of the partial annular parts 144a and 144b. In the annular shape maintaining part 146, an engaging protrusion 147 is formed. The engaging protrusion 147 can be engaged with an engaged part 144d that is formed at the circumferential end portion of the partial annular part 144b.

The fixing part 150 is formed so as to allow insertion and engagement of a plate-like fixing piece 84 that is provided at a fixing target 180. The fixing part 150 is integral with the annular shape maintaining part 146. Specifically, a box part is provided at the circumferential end portion of the partial annular part 144b, and the engaging protrusion 147 is formed at one end of the box part and the fixing part 150 is provided at another end of the box part.

### Third Embodiment

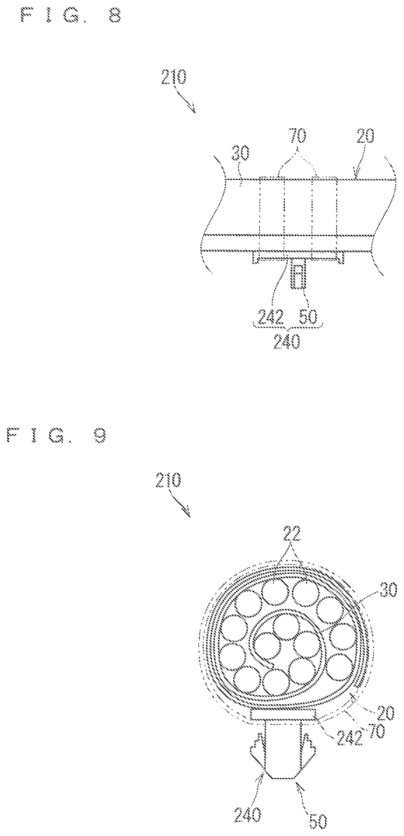

A wiring member with a fixing member according to the third embodiment will be described. FIG. 8 is a side view illustrating a wiring member with a fixing member 210 according to the third embodiment. FIG. 9 is a front view illustrating the wiring member with a fixing member 210 according to the third embodiment.

Regarding the wiring member with a fixing member 210 according to the present example, the shape of a fixing member 240 is different from the shape of the fixing members 40 and 140 according to the first and second embodiments. Specifically, in the present example as well, the fixing member 240 is a molded item obtained by integrally molding an attachment part 242 and the fixing part 50. The attachment part 242 according to the present example is a plate-like part 242 that is formed in to a long plate-like shape. The attachment is performed in a state in which the longitudinal direction of the plate-like part 242 extends along the longitudinal direction of the wiring member 20. One main surface of the plate-like part 242 faces the wiring member 20. The fixing part 50 is provided to protrude from another main surface of the plate-like part 242. Although the fixing part 50 is provided at an intermediate portion of the plate-like part 242 in the longitudinal direction) the fixing part 50 may be provided at an end portion of the plate-like part 242 in the longitudinal direction.

The wiring member with a fixing member 210 further includes a bundling member 70 that bundles the attachment part 242 and the wiring member 20. As the bundling member 70, for example, an adhesive tape 70 can be used. The adhesive tape 70 is wound around the plate-like part 242 and the wiring member 20 at positions in the plate-like part 242 except for the part where the fixing part 50 is provided.

The fixing member 240 is a molded item obtained by integrally molding the attachment part 242 and the fixing part 50. The attachment part 242 is formed into a plate-like shape extending in the longitudinal direction of the wiring member 20. The wiring member 20 with the fixing member 240 further includes the bundling member 70 that bundles the attachment part 242 and the wiring member 20. Thus, as the fixing member 240, the general-purpose taping-type clamp 240 or the like can be used as in the present example.

The above has described an example in which tho exterior member is a fixing member. However, the exterior member may be a member other than the fixing member. The following will describe an example in which the exterior member is a member other than the fixing member. The following describe an example in which the exterior member is a protective member.

### Fourth Embodiment

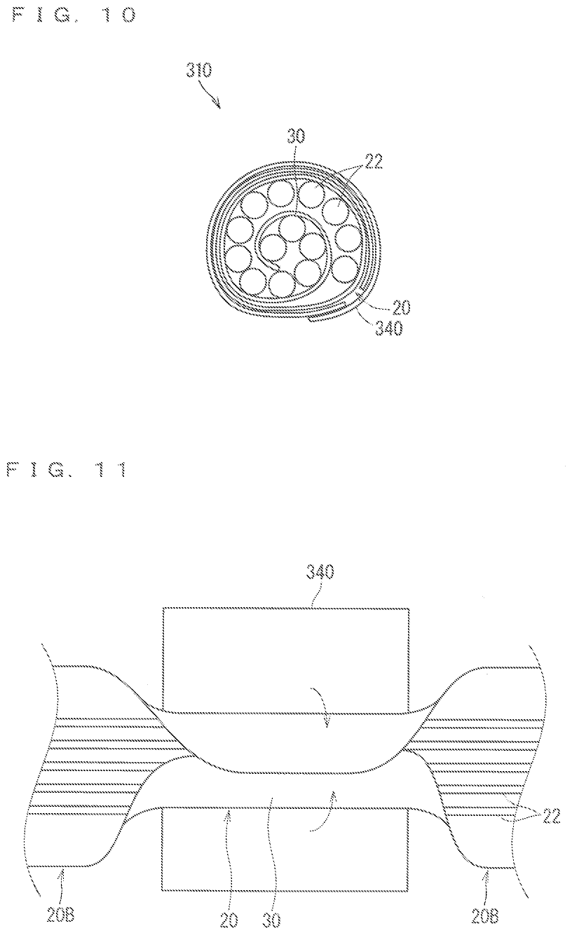

A wiring member with an exterior member according to the fourth embodiment will be described. The wiring member with an exterior member according to the fourth embodiment is an example in which the exterior member is an exterior sheet. In other words, the wiring member with an exterior member according to the fourth embodiment is a wiring member with an exterior sheet. FIG. 10 is a front view illustrating a wiring member with an exterior sheet 310 according to the fourth embodiment. FIG. 11 is an explanatory diagram illustrating a state in which the wiring member with an exterior sheet 310 according to the fourth embodiment is manufactured.

The exterior sheet 340 may include a solid sheet made of resin whose inside is uniformly filled. Although the resin is not particularly limited, PVC or the like may be used. Further, the exterior sheet 340 may include a foamed sheet.

As illustrated in FIG. 11, the wiring member 20 is in a state in which the width of at least a part of a region thereof along the longitudinal direction is reduced. For example, it is only necessary that, regarding the state in which the width is reduced in the wiring member 20, the width be reduced in comparison to the state in which the base material 30 is flat, that is, the wiring member 20 is the flat wiring member 20B. It can also be interpreted that, in the aspect ratio, the region having the reduced width in the wiring member 20 is smaller in the horizontal ratio and is larger in the vertical ratio than the flat wiring member 20B. For example, the state with the reduced width in the wiring member may be the spirally wound state illustrated in FIG. 2, or may be the folded state as in the example illustrated FIG. 4.

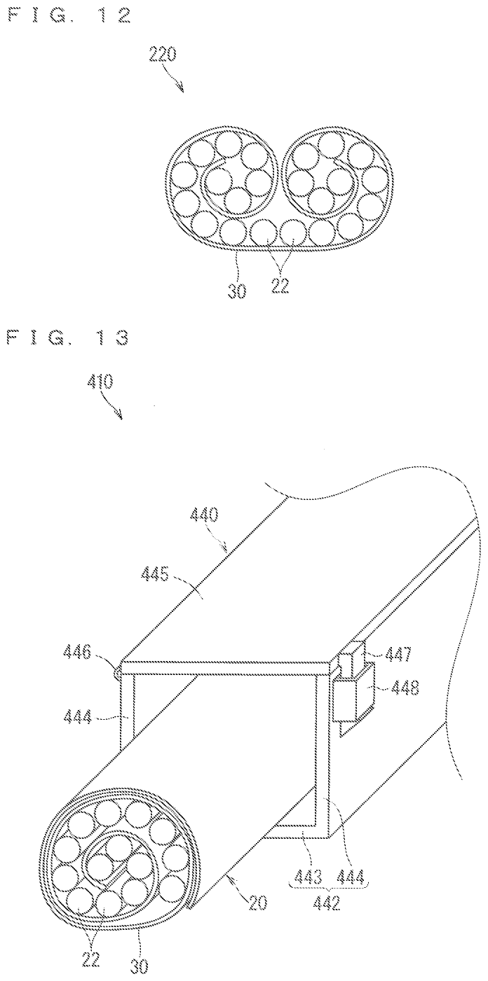

As illustrated in FIG. 12, the state with the reduced width in the wiring member may be a state in which both the side parts are respectively separately spirally wound. Note that, in the example of the wiring member 220 illustrated in FIG. 12, winding is performed so that the base material 30 is located on the outer side of the wire-like transmission members 22 at both the side parts along the width direction. However, this is not necessarily required. Winding may be performed so that the base material 30 is located on the inner side of the wire-like transmission members 22 at both the side parts. Alternatively, winding may be performed so that the base material 30 is located on the outer side of the wire-like transmission members 22 at one side part, and winding may be performed so that the base material 30 is located on the inner side of the wire-like transmission members 22 at another side part. If winding is performed spirally in a respectively separately manner at both the side parts as in the wiring member 220, the height can be lowered in comparison to a case in which winding is performed in one spiral manner from one side part toward another side part as in the wiring member 20.

Other than the above, the state with the reduced width in the wiring member may be a state in which the wiring member is twisted. Alternatively, for example, the state with the reduced width in the wiring member may be a state obtained by simply applying a force in the width direction from a flat state so as to be compressed. One example of this case is a state in which the fiat wiring member 20B is seized and deformed.

In the example illustrated in FIG. 11, the width of the wiring member 20 is reduced at the part where the exterior member is to be attached. In the wiring member 20, the width of the wiring member 20 need not be reduced at a part other than the part where the exterior member is to be attached. In the example illustrated in FIG. 11, the exterior member is attached to an intermediate portion of the wiring member 20. In the example illustrated in FIG. 11, the part where the width of the wiring member 20 is not reduced (here, a part where the flat wiring member remains flat) is present on both sides the part where the exterior member is to be attached along the longitudinal direction of the wiring member 20. In other words, the wiring member has a region having a larger width than the region where the exterior member is attached, on both the sides with respect to the region where the exterior member is attached along the longitudinal direction. In the example illustrated in FIG. 11, the region having a larger width is the part that remains as the flat wiring member 20B. However, the region may be a part where the width is reduced in a different manner. In the wiring member, both the sides of the region where the exterior member is attached have a large width, and thus the exterior member is less liable to be shifted along the longitudinal direction.

The exterior member may be attached to an end portion of the wiring member. The part where the width of the wiring member is not reduced may be present only on one side of the exterior member along the longitudinal direction of the wiring member. In other words, the wiring member may have a region having a width larger than the region where the exterior member is attached, only on one side with respect to the region where the exterior member is attached along the longitudinal direction. In this case, in the wiring member, the exterior member can be externally attached to the end portion, and a part on the intermediate portion side can be flat.

In the example illustrated in FIG. 11, there is a region whose width is gradually increased (width-increased region) from the part where the exterior member is attached (the region where the width is reduced) toward the part having a large width. The width-increased region is located on the outer side with respect to the exterior member along the longitudinal direction. With this, an edge is less liable to be generated between the region where the exterior member is attached and the region having a larger width, and damage due to the edge at the time of vibration or the like can be less liable to be caused.

The width-increased region need not be provided. For example, a slit may be provided in the sheet from an edge portion toward the intermediate portion in the width direction, so that the region having a reduced width and the region having a larger width may be provided across the slit.

A part in which the exterior sheet 340 is wound around the region having a reduced width of the wiring member 20 constitutes an attachment part. When the exterior sheet 340 is fixed to the wiring member 20, fixing mode is not particularly limited. For example, an adhesive agent, a double-sided adhesive tape, or the like may be interposed between the exterior sheet 340 and the wiring member 20, so that the exterior sheet 340 is fixed to the wiring member 20. Alternatively, for example, an adhesive tape may be wound around the end portion of the exterior sheet 340 and the wiring member 20 along the longitudinal direction of wiring member 20 so that the exterior sheet 340 is fixed to the wiring member 20.

Further, in the example illustrated in FIG. 10, the exterior sheet 340 is wound around the wiring member 20 with one end portion being located on the inner circumferential side, so that the cross-section is a spiral. The exterior sheet 340 may be wound around the wiring member 20 in a mode other than that described above. For example, the exterior sheet 340 may be wound in a state in which the intermediate portion is wound around the wiring member 20 and one end portion and another end portion overlap so that the same surface comes in contact on the outer side.

In a state in which the attachment part is attached to the wiring member, the state having a reduced width of the wiring member is maintained. Note that the state having a reduced width of the wiring member need not be maintained only at the attachment part. A member (for example, an adhesive tape or the like) for maintaining the state having a reduced width of the wiring member may be provided in addition to the attachment part.

In the region where the attachment part is attached, at least one of the attachment part and the base material entirely covers the plurality of wire-like transmission members 22 along the longitudinal direction. Here, in the region where the attachment part is attached, the attachment part, that is, the exterior sheet 340, entirely covers the plurality of wire-like transmission members 22 along the longitudinal direction. Further, here, in the region where the attachment part is attached, the base material 30 also entirely covers the plurality of wire-like transmission members 22 along the longitudinal direction.

According to the wiring member with an exterior sheet 310 configured as described above, the wiring member 20 can be protected by the exterior sheet 340.

### Fifth Embodiment

A wiring member with an exterior member according to the fifth embodiment will be described. The wiring member with an exterior member according to the fifth embodiment is an example in which the exterior member is a protector. In other words, the wiring member with an exterior member according to the fifth embodiment is a wiring member with a protector. FIG. 13 is a front view illustrating a wiring member with a protector 410 according to the fifth embodiment.

The protector 440 includes an accommodation part 442. The accommodation part 442 includes a bottom part 443, and a plurality of side wall parts 444 protruding from the bottom part 443. A space surrounded by the bottom part 443 and the plurality of side wall parts 444 is an accommodation space of the wiring member 20. In the accommodation part 442, the region having a reduced width of the wiring member 20 is accommodated. The accommodation part 442 constitutes the attachment part. The protector 440 is, usually, a resin molded item.

The protector 440 further includes a lid 445. The lid 445 is provided so as to be capable of opening and closing an opening of the accommodation part 442. Here, the lid 445 is coupled to the accommodation part 442 via a hinge 446 on one side part. The hinge 446 allows the lid 445 to be pivotable with respect to the accommodation part 442. With this, the lid 445 can open and close the opening of the accommodation part 442. Another side part of the lid 445 is locked by a lock part. Here, lock piece 447 is provided on the lid 445, and a locked part 448 is provided on the accommodation part 442. With the lock piece 447 being inserted into and locked by the locked part 448, the lid 445 is maintained in a state of closing the accommodation part 442. The protector 440 need not include the lid 445. When the protector does not include the lid 445, it is preferable that the base material 30 be exposed on the opening side in the wiring member 20. Even when the protector 440 includes the lid 445, the lid 445 may be a member separate from the accommodation part 442. In this case, it is sufficient that the lock part be provided on both the sides of the lid 445. Note that, in the protector 440, a fixing part fixed to the vehicle may be integrally provided. The fixing part may have a shape such as that of the fixing parts 50 and 150 or the like.

An extension piece (not shown) may be provided at an end portion of the accommodation part 442 along the longitudinal direction of the wiring member 20. The extension piece formed in such as a manner that a part of the bottom part 443 or the side wall part 444 extends toward the outer side of the accommodation part 442. A bundling member is wound around the wiring member 20 extending from the accommodation part 442 toward the outer side and the extension piece. With this, the protector 440 is positioned on the wiring member 20.

According to the wiring member with a protector 410 configured as described. above, the wiring member 20 can be protected by the protector 440.

### Sixth Embodiment

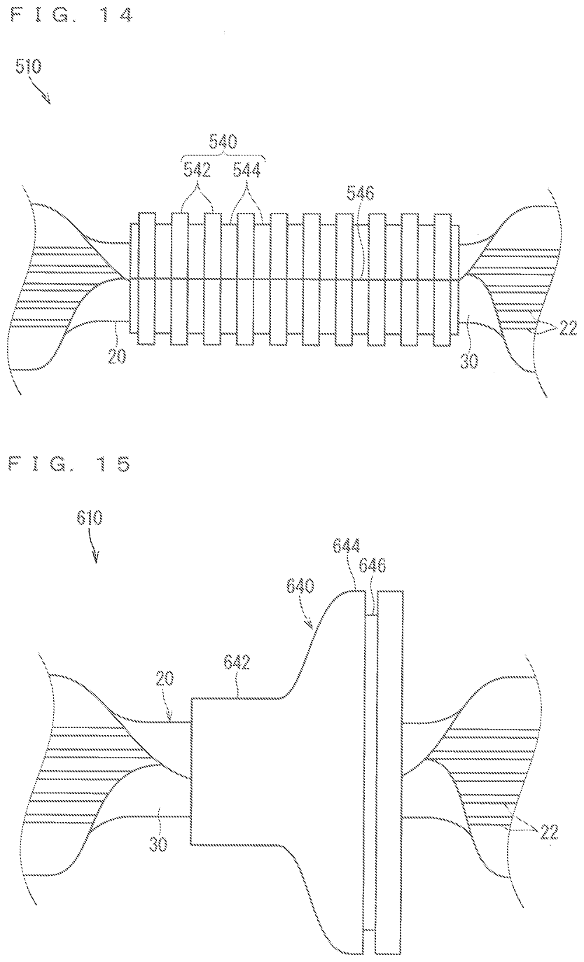

A wiring member with an exterior member according to the sixth embodiment will be described. The wiring member with an exterior member according to the sixth embodiment is an example in which the exterior member is a tube. In other words, the wiring member with an exterior member according to the sixth embodiment is a wiring member with a tube. FIG. 14 is a plan view illustrating a wiring member with a tube 510 according to the sixth embodiment.

In a tube 540, the region having a reduced width of the wiring member 20 is accommodated. The tube 540 itself constitutes the attachment part. The tube 540 is a member that is molded into a tubular shape in advance. The tube 540 is a member that can maintain its tubular shape even if the tube 540 is removed from the wiring member 20.

As the tube 540, in the example illustrated in FIG. 14, a corrugated tube 540 is adopted. The corrugated tube 540 includes annular projecting parts 542 and annular recessed parts 544. The annular projecting parts 542 and the annular recessed parts 544 alternately continue along the longitudinal direction. In other words, the tube is a member in which the same shape periodically continues along the longitudinal direction. The corrugated tube 540 is, usually, a resin molded item.

As the tube, a tube other than the corrugated tube 540 may be used. For example, the tube may be a molded tube made of resin having no projecting parts or recessed parts on its outer surface. In other words, the tube may be a member in which the same cross-sectional shape uniformly continues along the longitudinal direction. Alternatively, for example, the tube may be a tube made of a fiber material such as a knitted tube and a. woven tube or the like. Alternatively, for example, the tube may be a thermally shrinkable tube.

In the tube 540, a slit 546 is provided. The slit 546 extends from one end portion to another end portion along the longitudinal direction. The tube 540 is split from the part of the slit 546, and the wiring member 20 is accommodated inside the tube 540.

The slit 546 need not be provided in the tube. In this case, the wiring member 20 may be inserted from one end side-opening toward another end side-opening in the longitudinal direction of the tube.

According to the wiring member with a tube 540 configured as described above, the wiring member 20 can be protected by the tube 540.

### Seventh Embodiment

A wiring member with an exterior member according to the seventh embodiment will be described. The wiring member with an exterior member according to the seventh embodiment is an example in which the exterior member is a grommet. In other words, the wiring member with an exterior member according to the seventh embodiment is a wiring member with a grommet. FIG. 12 is a side view illustrating a wiring member with a grommet 610 according to the seventh embodiment.

A grommet 640 includes a small-diameter cylindrical part 642, and a large-diameter cylindrical part 644 that is connected to the small-diameter cylindrical part 642. The grommet 640 is made of an elastic material such as rubber and elastomer. In the small-diameter cylindrical part 642, the region having a reduced width of the wiring member 20 is accommodated. The small-diameter cylindrical part 642 constitutes the attachment part. An adhesive tape may be wound around an end portion of the small diameter cylindrical part 642 and the wiring member 20 extending from the end portion of the small-diameter cylindrical part 642. The inner surface of the small-diameter cylindrical part 642 may pressurize the wiring member 20. A water blocking material may be provided inside the small diameter cylindrical part 642. The water blocking material fills a gap between the inner surface of the small-diameter cylindrical part 642 and the wiring member 20. The water blocking material may be an adhesive agent that fixes both of the inner surface of the small-diameter cylindrical part and the wiring member 20 by bonding the inner surface and the wiring member 20 together.

A groove 646 is formed on the outer surface of the large-diameter cylindrical part 644. With a circumferential edge portion of a through hole formed in a panel or the like being accommodated in the groove 646, the grommet 640 is attached to the through hole.

The grommet may include a component made of hard resin, other than the component made of an elastic material. In this case, for example, the component made of hard resin is incorporated into the component made of an elastic material. An end surface of the large-diameter cylindrical part provided in the component made of an elastic material constitutes a lip part that comes in contact with one main surface of the circumferential edge portion of the through hole. Further, the engaging protrusion formed into the component made of hard resin is engaged with another main surface of the circumferential edge portion of the through hole. With this, the grommet is attached to the through hole.

According to the wiring member with a grommet 610 configured as described above, the wiring member 20 can be protected by the grommet 640.

The fourth embodiment to the seventh embodiment describe an example in which the exterior member is a protective member. As the protective member, a member that can be used for a conventional wire harness in which a plurality of electric wires are bundled may be adopted. Various protective members that can be used for a conventional wire harness have been put into use, and thus selection of the protective member that satisfies a necessary condition or the like is facilitated.

Regarding the fourth to seventh embodiments in which the exterior member is a protective member as it is preferable that the coefficient of friction in the outer surface of at least a part of a contact region with respect to the attachment part be set higher than the coefficient of friction in the outer surface of a non-contact region with respect to the attachment part, by using the intermediation member, increasing surface roughness of a part of the base material, or the like. The contact region refers to a part of the wiring member that comes in contact with the attachment part. The non-contact region refers to a part of the wiring member that does not come in contact with the attachment part. With this, the protective member is less liable to be shifted.

Note that each configuration described in each embodiment and each modification described above can be combined with each other as appropriate unless there is no inconsistency. For example, the configuration illustrated in the example in which the exterior member is a fixing member and the configuration illustrated in the example in which the exterior member is a protective member may be combined or replaced with each other as appropriate unless there is no inconsistency in particular.

### EXPLANATION OF REFERENCE SIGNS

10, 110, 210 Wiring member with fixing member

20, 120, 220 Wiring member

20B Flat wiring member

22 Wire-like transmission member

30 Base material

31a, 31b Main surface

32 Body part

34 Extension piece

40, 140, 240 Fixing member

42, 142, 242 Attachment part

44, 144 Annular part

144a, 144b Partial annular part

144c Hinge part

144d Engaged part

46, 146 Annular shape maintaining part

47 Body part

47h Band insertion hole

147 Engaging protrusion

50, 150 Fixing part

52 Pillar part

54 Engagement piece

60 Intermediation member

70 Bundling member

80,180 Fixing target

82 Through hole

84 Fixing piece

310 Wiring member with exterior sheet

340 Exterior sheet

410 Wiring member with protector

440 Protector

442 Accommodation part

443 Bottom part

444 Side wall part

445 Lid

446 Hinge

447 Lock piece

448 Locked part

510 Wiring member with tube

540 Tube

542 Annular projecting part

544 Annular recessed part

546 Slit

610 Wiring member with grommet

640 Grommet

642 Small-diameter cylindrical part

644 Large-diameter cylindrical part

646 Annular groove

1-18. (canceled)

19. A wiring member with an exterior member comprising:
a wiring member; and
an exterior member, wherein
the wiring member includes a plurality of wire-like transmission members and a base material,
the plurality of wire-like transmission members are fixed to the base material in an arrayed state,
the exterior member includes an attachment part,
the attachment part is attached to a region of the wiring member having a reduced width,
in a state in which the attachment part is attached to the wiring member, a state having the reduced width of the wiring member is maintained,
in the region where the attachment part is attached, at least one of the attachment part and the base material entirely covers the plurality of wire-like transmission members along a longitudinal direction, and
the wiring member has a region having a larger width than the region where the exterior member is attached, on both sides with respect to the region where the exterior member is attached along the longitudinal direction.

20. A wiring member with an exterior member comprising:
a wiring member; and
an exterior member, wherein
the wiring member includes a plurality of wire-like transmission members and a base material,
the plurality of wire-like transmission members are fixed to the base material in an arrayed state,
the exterior member includes an attachment part,
the attachment part is attached to a region of the wiring member having a reduced width,
in a state in which the attachment part is attached to the wiring member, a state having the reduced width of the wiring member is maintained,
in the region where the attachment part is attached, at least one of the attachment part and the base material entirely covers the plurality of wire-like transmission members along a longitudinal direction, and
the wiring member has a region having a larger width than the region where the exterior member is attached, only on one side with respect to the region where the exterior member is attached along the longitudinal direction.

21. The wiring member with an exterior member according to claim 19, wherein
the wiring member further includes a region provided so as to have the width gradually increased from the region where the exterior member is attached toward the region having the larger width.

22. The wiring member with an exterior member according to claim 19, wherein
in the region having the reduced width of the wiring member, cross-section is in a spirally wound state in the wiring member.

23. A wiring member with an exterior member comprising:
a wiring member; and
an exterior member, wherein
the wiring member includes a plurality of wire-like transmission members and a base material,
the plurality of wire-like transmission members are fixed to the base material in an arrayed state,
the exterior member includes an attachment part,
the attachment part is attached to a region of the wiring member having a reduced width,
in a state in which the attachment part is attached to the wiring member, a state having the reduced width of the wiring member is maintained,
in the region where the attachment part is attached, at least one of the attachment part and the base material entirely covers the plurality of wire-like transmission members along a longitudinal direction, and
in the region having the reduced width of the wiring member, cross-section is in a spirally wound state respectively separately on one side part and another side part in the wiring member.

24. The wiring member with an exterior member according to claim 19, wherein
the exterior member is a fixing member,
the fixing member includes the attachment part, and a fixing part being connected to the attachment part and being fixed to a fixing target of the wiring member, and
in the region having the reduced width of the wiring member, the base material is bent so as to surround the plurality of wire-like transmission members.

25. The wiring member with an exterior member according to claim 24, wherein
the fixing member is a molded item obtained by integrally molding the attachment part and the fixing part, and
the attachment part includes an annular part being capable of changing a state between an annular state and a non-annular state and surrounding the wiring member in the annular state, and an annular shape maintaining part being provided at one end portion of the annular part and stopping another end portion of the annular part to maintain the annular part in the annular state.

26. A wiring member with an exterior member comprising:
a wiring member; and
an exterior member, wherein
the wiring member includes a plurality of wire-like transmission members and a base material,
the plurality of wire-like transmission members are fixed to the base material in an arrayed state,
the exterior member includes an attachment part,
the attachment part is attached to a region of the wiring member having a reduced width,
in a state in which the attachment part is attached to the wiring member, a state having the reduced width of the wiring member is maintained,
in the region where the attachment part is attached, at least one of the attachment part and the base material entirely covers the plurality of wire-like transmission members along a longitudinal direction,
the exterior member is a fixing member,
the fixing member includes the attachment part, and a fixing part being connected to the attachment part and being fixed to a fixing target of the wiring member,
in the region having the reduced width of the wiring member, the base material is bent so as to surround the plurality of wire-like transmission members,
the fixing member is a molded item obtained by integrally molding the attachment part and the fixing part,
the attachment part includes an annular part being capable of changing a state between an annular state and a non-annular state and surrounding the wiring member in the annular state, and an annular shape maintaining part being provided at one end portion of the annular part and stopping another end portion of the annular part to maintain the annular part in the annular state, and
when a part of the wiring member coming in contact with the annular part constitutes a contact region, and a part of the wiring member not coming in contact with the annular part constitutes a non-contact region, a coefficient of friction in an outer surface of at least a part of the contact region with respect to the annular part is higher than a coefficient of friction in an outer surface of the non-contact region with respect to the annular part.

27. A wiring member with an exterior member comprising:
a wiring member; and
an exterior member, wherein
the wiring member includes a plurality of wire-like transmission members and a base material,
the plurality of wire-like transmission members are fixed to the base material in an arrayed state,
the exterior member includes an attachment part,
the attachment part is attached to a region of the wiring member having a reduced width,
in a state in which the attachment part is attached to the wiring member, a state having the reduced width of the wiring member is maintained,
in the region where the attachment part is attached, at least one of the attachment part and the base material entirely covers the plurality of wire-like transmission members along a longitudinal direction,
the exterior member is a fixing member,
the fixing member includes the attachment part, and a fixing part being connected to the attachment part and being fixed to a fixing target of the wiring member,
in the region having the reduced width of the wiring member, the base material is bent so as to surround the plurality of wire-like transmission members,
the fixing member is a molded item obtained by integrally molding the attachment part and the fixing part,
the attachment part includes an annular part being capable of changing a state between an annular state and a non-annular state and surrounding the wiring member in the annular state, and an annular shape maintaining part being provided at one end portion of the annular part and stopping another end portion of the annular part to maintain the annular part in the annular state,
the wiring member with an exterior member further comprises an intermediation member being fixed at an outer circumferential portion of the base material and being interposed between the annular part and the base material, and
a coefficient of friction in an outer surface of the intermediation member with respect to the annular part is higher than a coefficient of friction in an outer surface of the base material with respect to the annular part.

28. The wiring member with an exterior member according to claim 24, wherein
the fixing member is a molded item obtained by integrally molding the attachment part and the fixing part,
the attachment part is formed into a plate-like shape extending in a longitudinal direction of the wiring member, and
the wiring member with the exterior member further comprises a bundling member configured to bundle the attachment part and the wiring member.

29. The wiring member with an exterior member according to claim 19, wherein
the exterior member is an exterior sheet, and
a part in which the exterior sheet is wound around the region having the reduced width of the wiring member constitutes the attachment part.

30. The wiring member with an exterior member according to claim 19, wherein
the exterior member is a protector including an accommodation part, and
the accommodation part includes a bottom part, and a side wall part protruding from the bottom part, and the accommodation part accommodates the region having the reduced width of the wiring member to constitute the attachment part.

31. The wiring member with an exterior member according to claim 19, wherein
the exterior member is a tube, and
the tube accommodates the region having the reduced width of the wiring member to constitute the attachment part.

32. The wiring member with an exterior member according to claim 19, wherein
the exterior member is a grommet including a small-diameter cylindrical part, and a large-diameter cylindrical part being connected to the small-diameter cylindrical part, and
the small-diameter cylindrical part accommodates the region having the reduced width of the wiring member to constitute the attachment part.

33. The wiring member with an exterior member according to claim 19, wherein
the base material includes a body part in which the plurality of wire-like transmission members are disposed, and an extension piece in which the plurality of wire-like transmission members are not disposed, the extension piece extending from the body part, and
in the wiring member, the extension piece is wound around once or more on an outer side of the body part.

34. A wiring member with an exterior member comprising:
a wiring member; and
an exterior member, wherein
the wiring member includes a plurality of wire-like transmission members and a base material,
the plurality of wire-like transmission members are fixed to the base material in an arrayed state,
the exterior member includes an attachment part,
the attachment part is attached to a region of the wiring member having a reduced width,
in a state in which the attachment part is attached to the wiring member, a state having the reduced width of the wiring member is maintained,
in the region where the attachment part is attached, at least one of the attachment part and the base material entirely covers the plurality of wire-like transmission members along a longitudinal direction, and
when a part of the wiring member coming in contact with the attachment part constitutes a contact region, and a part of the wiring member not coming in contact with the attachment part constitutes a non-contact region, a coefficient of friction in an outer surface of at least a part of the contact region with respect to the attachment part is higher than a coefficient of friction in an outer surface of the non-contact region with respect to the attachment part.

35. A manufacturing method of a wiring member with an exterior member, comprising:
preparing a wiring member formed flat, the wiring member including a plurality of wire-like transmission members, and a base material in which the plurality of wire-like transmission members are fixed in an arrayed state;
reducing width of only a part of a region of the wiring member along a longitudinal direction; and
attaching an attachment part in the exterior member to the region having the reduced width in the wiring member, and maintaining the wiring member in a state with the reduced width and a state in which at least one of the attachment part and the base material entirely covers the plurality of wire-like transmission members along the longitudinal direction.
